(19) United States
(12) Patent Application Publication
(10) Pub. No.: US 2026/0361571 A1
(43) Pub. Date: Nov. 12, 2026

(54) ESTIMATING A PROPERTY OF A SIGNAL

(71) Applicant: Telefonaktiebolaget LM Ericsson (publ), Stockholm (SE)

(72) Inventors: Miguel BERG, Sollentuna (SE); Chenguang LU, Sollentuna (SE)

(21) Appl. No.: 19/470,406

(22) PCT Filed: Mar. 31, 2023
(86) PCT No.: PCT/SE2023/050292

§ 371 Date: Sep. 29, 2025

(51) Int. Cl. H04L 25/02

(52) U.S. Cl. CPC H04L 25/022

(57) ABSTRACT

Methods and apparatus are provided. In some examples, a method of estimating a property of a first signal is provided. The method comprises processing the first signal to obtain a first plurality of samples representing the first signal, and determining an exponentiation of at least a subset of the first plurality of samples to obtain a second plurality of samples using an exponent that is greater than 0 and less than 1. The method also comprises fitting a curve to the second plurality of samples, and determining a location of a peak of the curve.

### TECHNICAL FIELD

Example embodiments of this disclosure relate to estimating a property of a signal, such as for example a frequency or arrival time of a signal.

### BACKGROUND

Windowing is a well-known technique used in conjunction with e.g. short-time Fourier transforms to control the trade-off between mainlobe width and sidelobe level for magnitude peaks at the output of the transform. Many different types of windows are known, including for example rectangular, Hamming, Hanning, Kaiser and others.

In many applications it is desired to determine one or more properties (e.g. location and/or height) of a peak, for example for tone detection in frequency domain, angle-of-arrival for beamforming or triangulation purposes, delay estimation in time domain, time-difference of arrival for position localization purposes, or even for feature detection in the spatial domain (e.g. in images). When using the sample with maximum magnitude to represent a peak, the location uncertainty of the peak is +0.5 samples. The accuracy can be improved by increasing the sample rate (oversampling) or by model fitting. Increasing the sample rate is not always possible, for example due to restrictions on computational complexity, cost and/or power consumption.

J. O. Smith III et al, “PARSHL: An Analysis/Synthesis Program for Non-Harmonic Sounds Based on a Sinusoidal Representation,” International Computer Music Conference (ICMC-87), Tokyo, 1987 (available at https://ccrma.stanford.edu/~jos/parshi/parshi.pdf) proposes to fit a parabolic equation to a frequency-domain peak. The author found empirically that accuracy improves if fitting is done to dB values instead of samples on a linear scale.

### SUMMARY

Examples of this disclosure may have certain advantages. For example, a property of a signal may be estimated from one or more properties of a peak of samples representing the signal (such as peak position and/or magnitude) determined accurately without excessive computational complexity.

One aspect of the present disclosure provides a method of estimating a property of a first signal. The method comprises processing the first signal to obtain a first plurality of samples representing the first signal, and determining an exponentiation of at least a subset of the first plurality of samples to obtain a second plurality of samples using an exponent that is greater than 0 and less than 1. The method also comprises fitting a curve to the second plurality of samples, and determining a location of a peak of the curve.

Another aspect of the present disclosure provides apparatus for estimating a property of a first signal. The apparatus comprises a processor and a memory. The memory contains instructions executable by the processor such that the apparatus is operable to process the first signal to obtain a first plurality of samples representing the first signal, determine an exponentiation of at least a subset of the first plurality of samples to obtain a second plurality of samples using an exponent that is greater than 0 and less than 1, fit a curve to the second plurality of samples, and determine a location of a peak of the curve.

An additional aspect of the present disclosure provides apparatus for estimating a property of a first signal. The apparatus is configured to process the first signal to obtain a first plurality of samples representing the first signal, and determine an exponentiation of at least a subset of the first plurality of samples to obtain a second plurality of samples using an exponent that is greater than 0 and less than 1. The apparatus is also configured to fit a curve to the second plurality of samples, and determine a location of a peak of the curve.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method of estimating a property of a first signal;

FIG. 2 shows an example of the mainlobe of a sinc function and the residual error for parabolic equation models based on Taylor polynomials;

FIG. 3 shows an example of fitting a curve for an output signal of an IFFT function; and

FIG. 4 is a schematic of an example of an apparatus 400 for estimating a property of a first signal.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

In examples of this disclosure, at least three samples may be obtained representing a signal. These samples may be obtained from around the main lobe of a peak of interest. The magnitude of each sample value is raised to a power f, 0<f<1, and preferably f∈[0.4, 0.5]. Next, a curve, such as a parabolic equation, is fitted to the resulting values. Desired properties of the peak such as the location and/or magnitude may then be determined from the fitted curve. The magnitude operation does not have to be performed before the exponentiation, but can instead be done after the exponentiation, or even omitted if it is desired to determine the phase of the peak. However, applying a magnitude operation early may in some examples reduce the computational complexity in the following steps. The properties of the peak may provide an estimate of a property of a signal, such as frequency or arrival time.

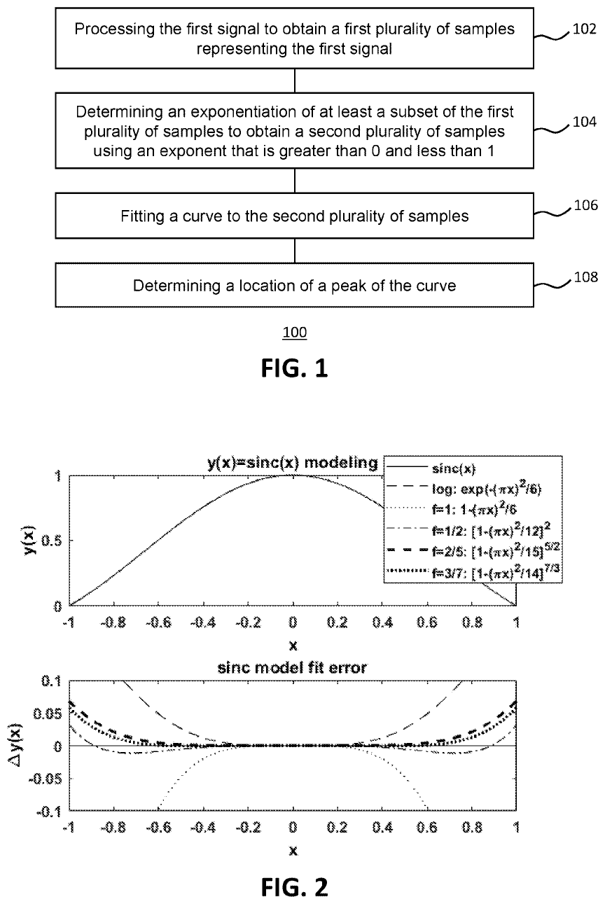

FIG. 1 is a flow chart of an example of a method 100 of estimating a property of a first signal. The method comprises, in step 102, processing the first signal to obtain a first plurality of samples representing the first signal. The processing may depend on the property that is to be estimated. For example, the property to be estimated may be a time offset between the first signal and a second signal, or a time of arrival of the first signal. In such examples, processing the first signal in step 102 may comprise cross-correlating the first signal and a second signal for a plurality of offsets between the first signal and the second signal. Thus, the first plurality of samples may comprise a first plurality of cross-correlation samples in some examples.

If the first and second signal are correlated (contain similarities, e.g., are linear functions of a same original signal, or are identical/substantially identical), the result of the cross-correlation may contain peaks indicating the relative displacement(s) where they are more correlated. If the first and second signals have a flat and bandlimited spectrum, or if the product of their spectrums is flat, the cross-correlation peaks will be shaped like sinc functions. Multiple correlation peaks can occur e.g. if the first and/or second signal comprises multiple copies (with different time offsets) of the original signal. Such multiple copies can occur for example due to multipath propagation due to reflections and/or diffraction. From the location of such correlation peaks, it is possible to determine a time offset between two signals, e.g. for the purpose of determining a UE position based on time-difference-of-arrival for an UE signal received at different base station antennas.

The second signal may be a locally stored signal, such as for example a predetermined sequence, reference sequence, or otherwise a sequence or signal cross-correlated with the first signal. Alternatively, the second signal may be for example a reflected first signal, a version of the first signal received at a different time and/or on a different frequency to the first signal (e.g. due to doppler shift, reflections, multipath, spatial multiplexing, etc), the same signal as the first signal received at a different antenna than the first signal, or the same signal as the first signal received at a different angle than the first signal.

In other examples, the property of the first signal to be estimated may be a property of frequency content of the first signal. Thus, for example, processing the first signal in step 102 may in some examples comprise processing the first signal to obtain a plurality of frequency samples representing frequency content of the first signal, wherein the first plurality of samples comprise the plurality of frequency samples. This may involve for example performing a Fourier transform on the first signal. Before the processing in step 102, a rectangular window (or other window) may be applied to the first signal in some examples. Applying a rectangular window, implicitly by sequence truncation or explicitly, may for example mean that any peaks after a Fourier transform have a sinc-like shape.

In some examples, frequency may refer to spatial frequency or frequencies in an angular spectrum. For example, a line-of-sight signal may be received at a (uniform) linear antenna array and Fourier transform may be performed across the array (on samples received at the same time but from different elements), which results in an angular spectrum with a peak in the direction of arrival for the signal. Locating the peak may thus be used to estimate the direction of arrival of the signal.

Referring again to FIG. 1, step 104 of the method 100 comprises determining an exponentiation of at least a subset of the first plurality of samples to obtain a second plurality of samples using an exponent that is greater than 0 and less than 1. That is, for example, for a sample s, an exponentiation sf is determined where 0<f<1. In some examples, the first plurality of samples comprise at least three samples. These can be used for example to fit a parabola. If a higher-order polynomial is fitted, then a minimum of more than three samples may be used in some examples. The subset of the first plurality of samples may comprise or include for example the largest sample (e.g. the sample of the largest magnitude) of the first plurality of samples and two samples of the plurality of samples adjacent to the largest sample.

In some examples, the exponent is greater than 0.1, greater than 0.2, greater than 0.3, greater than 0.4 or greater than 0.42. In some examples, the exponent is less than 0.9, less than 0.8, less than 0.7, less than 0.6, less than 0.5 or less than 0.44. In particular examples, the exponent is 0.5 (i.e. square root), 0.4, 3/7 or 0.43.

Step 106 of the method 100 comprises fitting a curve, such as for example a parabola, to the second plurality of samples. Step 108 of the method 100 comprises determining a location of a peak of the curve. The location of the peak of the curve may for example identify the property of the first signal. In some examples, determining the location of the peak of the curve identifies a time offset between the first signal and the second signal, an arrival time of the first signal, a frequency or main frequency of the signal, or some other property of the signal.

In some examples, the exponentiation in step 104 is performed on magnitudes of the samples, for example in cases where the samples are complex numbers. Therefore, for example, determining the exponentiation of at least the subset of the first plurality of cross-correlation samples to obtain a second plurality of samples in step 104 may comprise determining the exponentiation of magnitudes of at least the subset of the first plurality of samples. Additionally or alternatively, in some examples, fitting the curve to the second plurality of samples may comprise fitting the curve to magnitudes of the second plurality of samples.

In some examples, the method 100 may be performed by a device that receives the first signal, such as for example a base station or User Equipment (UE). Hence, in some examples, the method 100 comprises receiving the first signal, and also in some examples receiving the second signal referred to above.

The following describes an example where a parabola is fitted to the first plurality of samples, and provides an explanation of the effects and benefits of examples of this disclosure.

Equation of a parabola is as follows:

y(x)=a(x−x₀)²+b.

A simple analysis shows that using a logarithm on samples such as cross-correlation samples, such as when converting to dB values, should be optimal (at least for high SNR) if the peak (or pulse) shape is Gaussian, since the logarithm of a Gaussian shape is indeed a parabola:

$$Gaussian pulse g ( x ) = \frac{1}{σ \sqrt{2 π}} {e}^{- \frac{1}{2} \cdot \frac{1 {( x - μ )}^{2}}{σ}} ,$$

$$and log ( g ( x ) ) = log ( \frac{1}{σ \sqrt{2 π}} ) \cdot - \frac{1}{2} \cdot \frac{{( x - μ )}^{z}}{σ}$$

Truly Gaussian pulses have infinite duration, but many common tapering windows yield pulse shapes resembling a Gaussian (e.g., Kaiser). A problem with Gaussian-like tapering windows is that power is lost, which leads to reduced SNR. With a rectangular window, no power is lost, and the main lobe has minimum width, but the pulse shape becomes a sinc function, i.e. sin (πx)/(πx) function, which has high sidelobe levels. For some applications, low sidelobe levels are more important while for other applications, high SNR or narrow main lobe (high peak resolution) are more important. In the following discussion, it is assumed that SNR is more important and that the pulse is sinc-shaped, i.e. that a rectangular (or close to rectangular) window has been used.

It is noted that a Taylor series expansion of sinc(x)=sin(πx)/(πx) contains only even-order exponents of x:

$$taylor ( sinc ( x ) , x ) = 1 - \frac{{( π x )}^{2}}{6} + \frac{{( π x )}^{4}}{120} - \frac{{( π x )}^{6}}{5040} + σ ( {x}^{8} ) = 1 - \frac{1}{6} ( {( π x )}^{2} - \frac{{( π x )}^{4}}{20} + \frac{{( π x )}^{6}}{840} - σ ( {x}^{8} ) )$$

In J. O. Smith III et al, “PARSHL: An Analysis/Synthesis Program for Non-Harmonic Sounds Based on a Sinusoidal Representation,” referred to above, it is proposed to use a logarithm before the fitting:

$$taylor ( log ( sinc ( x ) ) , x ) = - \frac{{( π x )}^{2}}{6} - \frac{{( π x )}^{4}}{180} - \frac{{( π x )}^{6}}{2835} - σ ( {x}^{8} ) = - \frac{1}{6} ( {( π x )}^{2} + \frac{{( π x )}^{4}}{30} + \frac{2 {( π x )}^{6}}{935} + σ ( {x}^{8} ) )$$

Here the constant term disappears, and the fourth order term is reduced by 33%, but the sixth order term almost doubles in magnitude. Thus, the logarithm function used on the first plurality of samples is not suitable for determining the location of peaks that resemble a sinc function.

Instead, the inventors have found that the square root of the sinc(x) function has much less energy in high-order terms compared with the sinc(x) function itself:

$$taylor ( \sqrt{s i n c ( x )} , x ) = 1 - \frac{{( π x )}^{2}}{12} + \frac{{( π x )}^{4}}{1440} - \frac{{( π x )}^{6}}{24192} + σ ( {x}^{8} ) = 1 - \frac{1}{12} ( {( π x )}^{2} - \frac{{( π x )}^{4}}{120} + \frac{{( π x )}^{6}}{2016} - σ ( {x}^{8} ) )$$

Using an exponent of 2/5=0.4 instead of square root (exponent 0.5) cancels the 4th order term completely, but the 6^{th} order term becomes stronger:

$$taylor ( {sinc}^{0.4} ( x ) , x ) = 1 - \frac{{( π x )}^{2}}{15} - \frac{{( π x )}^{6}}{23625} + σ ( {x}^{8} ) = 1 - \frac{1}{15} ( {( π x )}^{2} + \frac{{( π x )}^{6}}{1575} - σ ( {x}^{8} ) )$$

Further investigations have shown that the 6^{th} order term is better suppressed for an exponent close to 0.43 (e.g. 3/7≈0.4286):

$$taylor ( {sinc}^{3 / 7} ( x ) , x ) = 1 - \frac{{( π x )}^{2}}{14} + \frac{{( π x )}^{4}}{5880} - \frac{{( π x )}^{6}}{740880} + σ ( {x}^{8} ) = 1 - \frac{1}{14} ( {( π x )}^{2} - \frac{{( π x )}^{4}}{420} + \frac{{( π x )}^{6}}{52920} - σ ( {x}^{8} ) )$$

Higher order terms have more impact when x is far away from 0 while low order terms have more impact close to 0. To summarize the above, taking an exponentiation of the first plurality of samples, fitting a curve to the exponentiated samples, and finding the peak of the curve, may have advantages as compared to where the curve is fitted to the samples themselves or logarithms of the samples.

FIG. 2 shows an example of the mainlobe of a sinc function, and the residual error for parabolic equation models based on the Taylor polynomials, when exponentiation is applied for various examples of the exponent f and also where the logarithm function is used on the samples. This indicates how good the model fit could be if there is no noise. As can be seen, the model fit error when fitting to |y(n)|^{f} with f∈[0.4, 0.5] has a much smaller error than for f=1, or when fitting to log |y(n)|. In the center 75% of the mainlobe, f=3/7 performs best of the tested exponent values, and has a fit error magnitude less than 0.01. Outside that region, near the mainlobe edges, f=1/2 is slightly better, but the center part may be more important in some examples since it contains more energy. For the center 60%, the magnitude of the fit error for f=3/7 is even below 0.001. However, there may be reasons to select f=1/2, such as for example if efficient square root operation is supported.

With a change in notation, the equation for a parabola can be written as:

y(n)=a(n−n₀−p)²+b

Here, no is a sample index where |y(n₀)| has a maximum (local or global), e.g. is the largest sample (e.g. the sample with the largest magnitude) of the first plurality of samples referred to above. In some examples, since the peak of the samples could be modulated and thus have varying phase, e.g. is a complex value, it may be preferred to fit to the magnitude of the data samples. To fit a parabola to |y(n)|/using three samples around (and including) n=n₀, one can calculate as follows:

$$2 a = {\vert y ( {n}_{0} - 1 ) \vert}^{f} + {\vert y ( {n}_{0} + 1 ) \vert}^{f} - 2 {\vert y ( {n}_{0} ) \vert}^{f}$$

$$c = - 2 a p = \frac{{\vert y ( {n}_{0} + 1 ) \vert}^{f} - {\vert y ( {n}_{0} - 1 ) \vert}^{f}}{2}$$

$$p = - \frac{c}{2 a} , with p ∈ [ - 0 \text{.5} , 0.5 ]$$

$$b = {\vert y ( {n}_{0} ) \vert}^{f} - a {p}^{2}$$

If needed, Newton's method can be used in some examples to iteratively calculate y^{f} for the three samples mentioned above:

$${x}_{n + 1} = ( 1 - f ) \cdot {x}_{n} + \frac{f \cdot y}{{x}_{n}^{\frac{1}{f} - 1}}$$

For f=1/2, the iteration step becomes

$${x}_{n + 1} = \frac{1}{2} ( {x}_{n} + \frac{y}{{x}_{n}} ) ,$$

which is quite simple to calculate. It requires inversion 1/xₙ but no other power of xₙ. Other values of f may lead to more complicated formulas.

Based on the output from the curve (e.g. parabolic equation) fit, in some examples it is possible to determine one or more different properties of the peak of the curve. The properties may include for example one or more of the following:
Peak position: n₀+p
Peak magnitude:

$${b}^{\frac{1}{t}}$$

Peak magnitude (dB):

$$\frac{20}{f} {log}_{10} ( b )$$

Peak width (−3 dB):

$${w}_{3 d B} = 2 \sqrt{\frac{b}{a} ( {( \sqrt{0.5} )}^{f} b - 1 )}$$

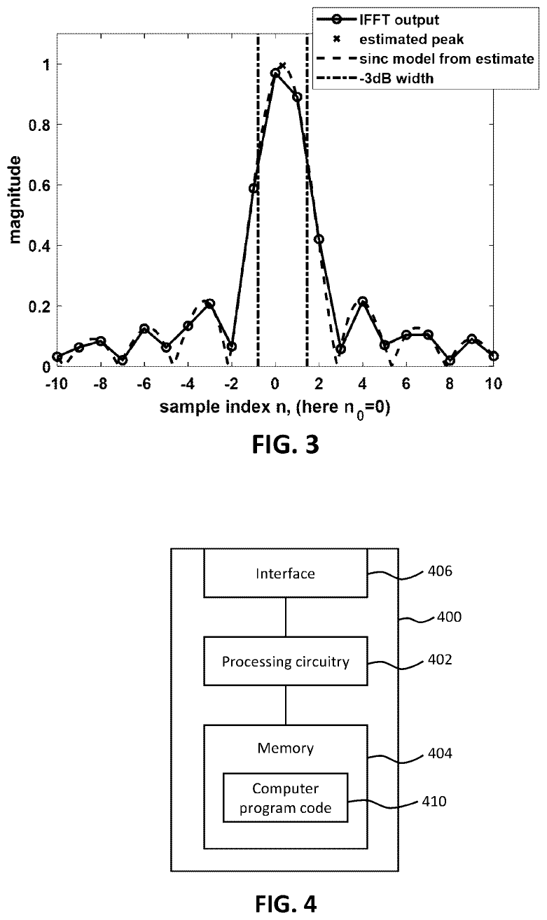

FIG. 3 shows an example of fitting a curve, in this case fitting a sinc function, for an output signal of an Inverse Fast Fourier Transform (IFFT) function with rectangular window and 2.5× oversampling (by zero padding). A sinc curve is fit by fitting a parabola to the output signal and then using the parabola parameters to determine a sinc curve to fit. In this particular example, frequency-domain samples were obtained and a rectangular window applied thereto in the frequency domain followed by the IFFT to obtain time-domain samples with a sinc-shaped peak. The IFFT function output (i.e. samples) is represented by small circles and the curve fit uses the magnitude values indicated by the circles for sample index n={n₀−1, n₀, n₀+1}, where in this particular example n₀=0. The position and magnitude of the estimated peak is indicated by a small ‘x’ near n=0 and with magnitude 1. From the sinc curve fit, a new sinc pulse is shown in FIG. 3 for illustration as a dashed curve. Dash-dotted lines are used to indicate the estimated −3 dB width of the peak. It can be seen that the fitted sinc curve is a good fit since it crosses all sample values from the IFFT function output.

Numerical evaluation was performed to test the peak-localization performance of examples of this disclosure. In a particular example, 30000 sinc pulses were generated with random (fractional) delay in the range [−1, 1] samples. Additive noise was added with selected Signal-to-Noise Ratio (SNR), i.e. both 10 dB and 30 dB as indicated in Table 1 below. Parabolic equation fitting was done for different methods (i.e. the logarithm function and exponentiation with different values for the exponent) and statistics were collected. For comparison, for the prior art method of using the sample with largest magnitude as the peak position, the standard deviation of the position error is approximately 29% of the sample time while the peak error is 50% of the sample time.

The results of the example numerical evaluation of peak-position error are summarized in Table 1 below, where it is seen that for high SNR (30 dB case) examples of this disclosure reduce the standard deviation of the error by up to an order of magnitude compared with prior art (fitting to |y(n)| and log |y(n)|). For lower SNR (10 dB case), the improvement is smaller, which is expected since the peak position error is limited by noise in that case.

TABLE 1
Peak-position estimation error indicated in percent of sample
time for 30 dB and 10 dB SNR. At the higher SNR level, there
is significant reduction of the standard deviation for examples
of this disclosure (last three rows) compared with the prior
art. As expected, there is smaller gain at lower SNR, but examples
of this disclosure still behave well in this region.

| | |
|---|---|
| 30 dB SNR | 10 dB SNR |

| | | Standard | | Standard |
|---|---|---|---|---|
| | Mean | deviation | Mean | deviation |
| \|y(n)\| | 0.02% | 1.13% | 0.00% | 1.56% |
| log\|y(n)\| | 0.01% | 0.86% | 0.00% | 1.38% |
| \|y(n)\|^{1/2} | 0.00% | 0.17% | 0.01% | 1.09% |
| \|y(n)\|^{2/5} | 0.00% | 0.12% | 0.01% | 1.08% |
| \|y(n)\|^{3/7} | 0.00% | 0.11% | 0.00% | 1.07% |

Table 2 below shows the result of a similar evaluation, but for peak magnitude. It can again be seen that examples of this disclosure significantly reduce the standard deviation of the error at high SNR while the reduction at low SNR is smaller. However, the bias error (mean value) is significantly reduced for both high and low SNR.

TABLE 1
Peak-magnitude estimation error in dB for 30 dB and 10 dB SNR.
At the higher SNR level, there is significant reduction of
the standard deviation compared with the prior art. For both
high and low SNR cases, examples of this disclosure reduce
the bias (mean values) of the magnitude estimation.

| | |
|---|---|
| 30 dB SNR | 10 dB SNR |

| | | Standard | | Standard |
|---|---|---|---|---|
| | Mean | deviation | Mean | deviation |
| \|y(n)\| | 0.036 dB | 0.030 dB | 0.035 dB | 0.074 dB |
| log\|y(n)\| | 0.033 dB | 0.029 dB | 0.034 dB | 0.074 dB |
| \|y(n)/^{1/2} | 0.005 dB | 0.008 dB | 0.005 dB | 0.068 dB |
| \|y(n)\|^{2/5} | 0.002 dB | 0.007 dB | 0.003 dB | 0.068 dB |
| \|y(n)\|^{3/7} | 0.000 dB | 0.007 dB | 0.000 dB | 0.068 dB |

FIG. 4 is a schematic of an example of an apparatus 400 for estimating a property of a first signal. The apparatus 400 comprises processing circuitry 402 (e.g. one or more processors) and a memory 404 in communication with the processing circuitry 402. The memory 404 contains instructions, such as computer program code 410, executable by the processing circuitry 402. The apparatus 400 also comprises an interface 406 in communication with the processing circuitry 402. Although the interface 406, processing circuitry 402 and memory 404 are shown connected in series, these may alternatively be interconnected in any other way, for example via a bus.

In one embodiment, the memory 404 contains instructions executable by the processing circuitry 402 such that the apparatus 400 is operable/configured to process the first signal to obtain a first plurality of samples representing the first signal, determine an exponentiation of at least a subset of the first plurality of samples to obtain a second plurality of samples using an exponent that is greater than 0 and less than 1, fit a curve to the second plurality of samples, and determine a location of a peak of the curve. In some examples, the apparatus 400 is operable/configured to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of estimating a property of a first signal, the method comprising:
processing the first signal to obtain a first plurality of samples representing the first signal;
determining an exponentiation of at least a subset of the first plurality of samples to obtain a second plurality of samples using an exponent that is greater than 0 and less than 1;
fitting a curve to the second plurality of samples; and
determining a location of a peak of the curve,
wherein processing the first signal to obtain the first plurality of samples representing the first signal comprises cross-correlating the first signal and a second signal for a plurality of offsets between the first signal and the second signal, wherein the first plurality of samples comprise a first plurality of cross-correlation samples.

2-8. (canceled)

9. The method of claim 1, wherein determining the location of the peak of the curve identifies a time offset between the first signal and the second signal.

10. The method of claim 1, comprising determining an arrival time of the first signal based on the location of the peak of the curve.

11-19. (canceled)

20. A computer program product comprising non transitory computer readable media having stored thereon a computer program comprising instructions which, when executed on at least one processor, cause the at least one processor to carry out a method according to claim 1.

21. Apparatus for estimating a property of a first signal, the apparatus comprising a processor and a memory, the memory containing instructions executable by the processor such that the apparatus is operable to:
process the first signal to obtain a first plurality of samples representing the first signal by cross-correlating the first signal and a second signal for a plurality of offsets between the first signal and the second signal, wherein the first plurality of samples comprise a first plurality of cross-correlation samples;
determine an exponentiation of at least a subset of the first plurality of samples to obtain a second plurality of samples using an exponent that is greater than 0 and less than 1;
fit a curve to the second plurality of samples; and
determine a location of a peak of the curve.

22-28. (canceled)

29. The apparatus of claim 21, wherein determining the location of the peak of the curve identifies a time offset between the first signal and the second signal.

30. The apparatus of claim 21, wherein the memory contains instructions executable by the processor such that the apparatus is operable to process the first signal to obtain the first plurality of samples representing the first signal by processing the first signal to obtain a plurality of frequency samples representing frequency content of the first signal, wherein the first plurality of samples comprise the plurality of frequency samples.

31-32. (canceled)

33. The apparatus of claim 21, wherein the memory contains instructions executable by the processor such that the apparatus is operable to determine an arrival time of the first signal based on the location of the peak of the curve.

34-37. (canceled)

38. Apparatus for estimating a property of a first signal, the apparatus configured to:
process the first signal to obtain a first plurality of samples representing the first signal;
determine an exponentiation of at least a subset of the first plurality of samples to obtain a second plurality of samples using an exponent that is greater than 0 and less than 1;
fit a curve to the second plurality of samples; and
determine a location of a peak of the curve.

39. The apparatus of claim 38, wherein the apparatus is configured to perform the method of claim 2.
